(19) United States
(12) Patent Application Publication
(10) Pub. No.: US 2025/0144839 A1
(43) Pub. Date: May 8, 2025

(54) Display Arrangement for Fixed Base Routers

(71) Applicant: Robert Bosch GmbH, Stuttgart (DE)

(72) Inventor: Stephen Claude Oberheim, Arlington Heights, IL (US)

(21) Appl. No.: 18/503,703

(22) Filed: Nov. 7, 2023

(51) Int. Cl. B27C 5/10

(52) U.S. Cl. CPC B27C 5/10

(57) ABSTRACT

A router assembly includes a base portion with a foot portion with a workpiece contact surface, and a cylindrical motor receiving bore above the foot portion. A cylindrical motor housing portion is configured to be clamped within the cylindrical motor receiving bore and a battery receptacle portion is fixedly positioned with respect to the cylindrical motor housing portion and configured to couple with a battery. The battery receptacle portion includes a cavity with a mouth providing access to coupling structures in the cavity, an uppermost part of the mouth defined at least in part by a horizontally extending planar surface portion. A display is supported by the cylindrical motor housing portion such that when the battery is coupled with the battery receptacle, with a portion of the battery within the cavity, a portion of the display is positioned higher than the uppermost planar surface.

### FIELD

The present disclosure relates to routers used to machine features into materials and more specifically to portable routers.

### BACKGROUND

Routers are used for a variety of woodworking purposes including finishing work for furniture and cabinets as well as functional connections made of complimentary shaped profiles such as tongue and groove joints, etc. Routers typically are of two types: table routers in which the work piece is moved relative to a stationary router and portable routers that are moved along the work piece.

Table routers utilize a router bit that extends upwardly above the top of a table to which the router is mounted. The router bit is stationary and is positioned in alignment with a longitudinally extending fence. The work piece is advanced from right to left along the top of the table, along the fence, and into the router bit to perform the work. The router bit in many applications is powered by a dedicated motor.

In many cases, the routers used in table router systems are portable routers that are mounted to a table using a mounting plate such that the router bit extends upwardly through the table. The use of a portable router as a table router reduces the number of routers that a company or individual must keep in inventory while providing the capabilities of both a portable router and a table router.

Portable routers are generally provided in two different styles: fixed-base and plunge base. A fixed-base router, also known as a standard router, has a base that removably clamps directly to a movable motor housing making the router a “fixed” unit. The bit height is established by the vertical height at which the movable motor housing is clamped with the base. Plunge routers typically include a housing that is vertically movable relative a base on two guide posts that are connected to the base. The motor housing in a plunge router is configured to be clamped at a single vertical position within the base housing.

In each style, a typical router base consists of a housing or casting with high cylindrical side walls. The motor unit is inserted into the center of the cylindrical walls and clamped within the router base housing. As noted above, for fixed base routers, the location of the motor unit is adjusted up or down in order to adjust the depth of cut of the router bit. When the router is in the lowest position the side walls of the base come up relatively close to the top of the router.

Both fixed base and plunge routers are now designed to be mostly cordless. Hence they include a large battery on top of the router to provide power for the assembly. These batteries should be mounted as low as possible in order to prevent the router from becoming top heavy. Also it is desirable to keep the center of gravity of the battery aligned with the center of gravity of the router to further assist in maintaining stability of the router.

The ever-increasing capability of low-cost electronics is leading to the inclusion of more and more electronic functions and sensors on power tools to make the power tools more “user-friendly” and to increase the capabilities of the power tools. These functions and sensors provide additional capability for the user to gather more information about the operating status of the power tool and enable higher quality results with increased speed as well as notifying the user of undesirable or even unsafe conditions. The ability to provide an interface to a user to display the available data, however, is severely limited by the profile of the router when attempting to optimize the location of the center of gravity.

What is needed is a configuration of a router assembly which allows a battery to be mounted relatively low on a base with high walls while still providing for a large display to be incorporated into the assembly. A further need exists for a configuration which allows a large display to be incorporated while allowing the center of gravity of the assembled router assembly to be aligned with the axis of the output shaft of the router assembly.

### SUMMARY

The present disclosure is directed to a router assembly which in one embodiment includes a base portion. The base portion includes a foot portion with a workpiece contact surface which is configured to be positioned on the surface of a workpiece and defines a first plane. The base portion further includes a cylindrical motor receiving bore located above the foot portion. The assembly includes a cylindrical motor housing portion configured to be clamped within the cylindrical motor receiving bore, and a battery receptacle portion fixedly positioned with respect to the cylindrical motor housing portion and configured to couple with a battery using mechanical coupling structures, the battery receptacle portion including a cavity with a mouth providing access to the mechanical coupling structures which are located in the cavity, an uppermost part of the mouth defined at least in part by a horizontally extending planar surface portion. A display is supported by the cylindrical motor housing portion such that when the battery is coupled with the battery receptacle portion, with at least a portion of the battery within the cavity, at least a portion of the display is positioned higher than the uppermost planar surface portion. This allows for a significantly larger display to be incorporated into the router assembly as compared to known router assemblies.

In at least one embodiment, the battery receptacle includes a battery receptacle housing coupled to the motor housing, and the display is mounted in a display housing portion. At least a portion of the display housing portion is integrally formed with at least a portion of the battery receptacle housing.

In one or more embodiments, the cylindrical motor receiving bore defines an axis perpendicular to the first plane and a first radius from the axis. A radially innermost portion of the display housing defines a second radius from the axis, and the second radius is larger than the first radius.

In one or more embodiments, the router assembly is configured such that when the battery is coupled with the battery receptacle, the center of gravity of the assembled router assembly is substantially aligned with the output shaft of the router assembly. As used herein, “substantially aligned” means that the distance between the center of gravity of the assembled router assembly and the axis defined by the output shaft of the router is within 20% of the distance defined by the first radius.

In one or more embodiments, the base portion is a fixed base portion.

In one or more embodiments, the base portion is a plunge base portion.

A power portion for a router assembly includes a cylindrical motor housing portion configured to be clamped within a cylindrical motor receiving bore of a base portion of the router assembly. A battery receptacle portion is fixedly positioned above the cylindrical motor housing portion and configured to couple with a battery, the battery receptacle portion including a cavity with a mouth providing access to coupling structures in the cavity, an uppermost part of the mouth defined at least in part by a horizontally extending planar surface portion. A display is supported by the cylindrical motor housing portion with at least a portion of the display positioned higher than the horizontally extending planar surface portion. The cavity is configured to receive at least a portion of the battery when the battery is coupled to the battery receptacle portion using the coupling structures.

In one or more embodiments, the power portion battery receptacle portion includes a battery receptacle housing coupled to the motor housing, the display is mounted in a display housing portion, and at least a portion of the display housing portion is integrally formed with at least a portion of the battery receptacle housing.

In one or more embodiments, the power portion cylindrical motor receiving bore defines a first axis. The cylindrical motor receiving bore defines a first radius from the first axis. A radially innermost portion of the display housing defines a second radius from the first axis. The second radius is larger than the first radius.

### BRIEF DESCRIPTION OF THE DRAWINGS

FIG. 1 shows a front perspective view of a router assembly incorporating an enhanced display.

FIG. 2 shows a top perspective view of the base portion of the router assembly of FIG. 1.

FIG. 3 shows a front view of the power portion of the router assembly of FIG. 1.

FIG. 4 shows a side view of the power portion of the router assembly of FIG. 1.

FIG. 5 shows a top perspective view of the power portion of the router assembly of FIG. 1.

FIG. 6 shows a perspective view of the battery of the router assembly of FIG. 1.

FIG. 7 shows a side perspective view of the router assembly of FIG. 1.

FIG. 8 shows an alternative base portion that can be used with the power portion of the router assembly of FIG. 1.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

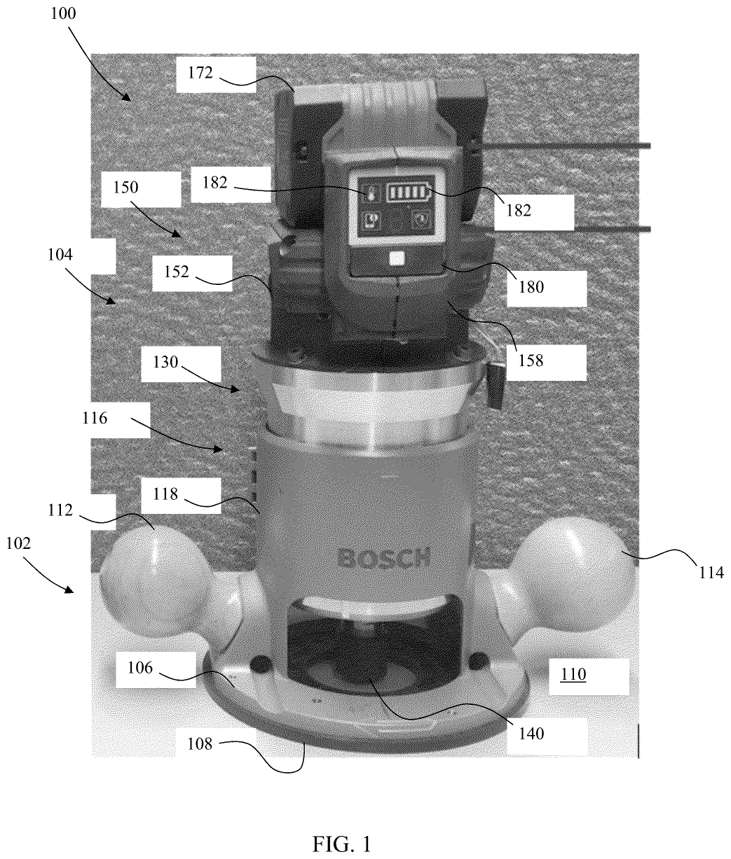

FIG. 1 depicts a router assembly 100 having a base portion 102 and a power portion 104. The base portion 102 includes a foot portion 106 with a workpiece contact surface 108 which is configured to be positioned on the surface of a workpiece 110. The workpiece contact surface 108 is provided as a planar component to allow for movement along the workpiece 110. Two handles 112/114 are coupled to the foot portion 106 to allow a user to easily move the router assembly 100 along the plane defined by the planar contact surface 108.

Located above the foot portion 106 is a cylindrical motor receiving portion 116. The cylindrical motor receiving portion 116 includes a wall portion 118 which defines a cylindrical motor receiving portion bore 120 as further shown in FIG. 2. The cylindrical motor receiving portion bore 120 defines a central axis 122 which is perpendicular to the plane defined by the workpiece contact surface 108. Also shown in FIG. 2 is a clamp 124.

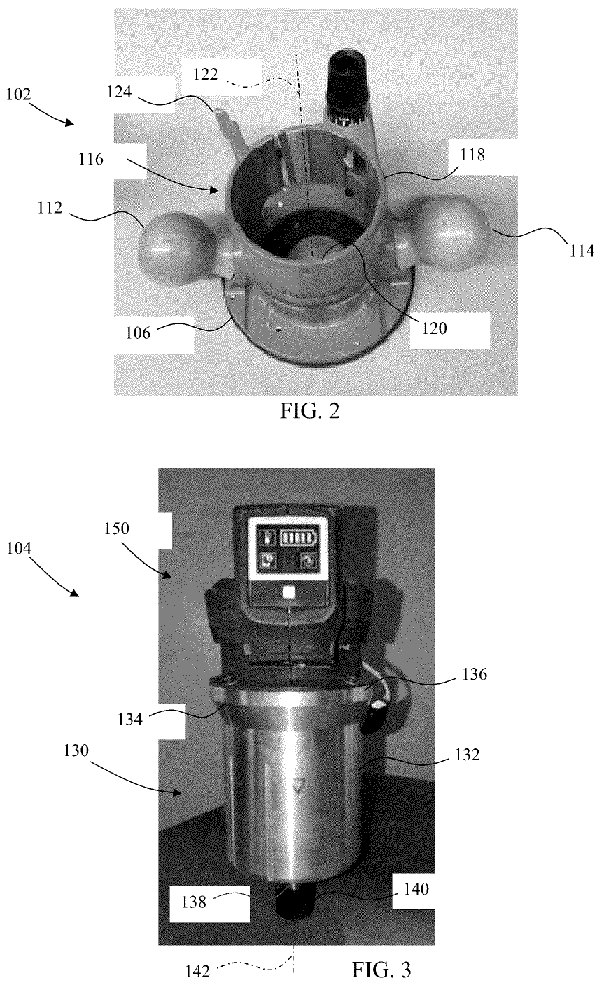

Returning to FIG. 1, the power portion 104 includes a cylindrical motor housing portion 130 which is shown positioned within the cylindrical motor receiving portion bore 120 (see FIG. 2). The cylindrical motor housing portion 130, further shown in FIG. 3, includes a cylindrical portion 132, a beveled portion 134, and a coupling portion 136. A motor (not shown) located within the cylindrical motor housing portion 130 drives an output shaft 138 which extends outwardly of the cylindrical portion 132 and is coupled to a chuck 140 to which a desired working tool (not shown) such as a router bit is removably coupled.

When positioned within the cylindrical motor receiving portion bore 120 as shown in FIG. 1, the cylindrical motor housing portion 130 is securely clamped at a desired vertical position using the clamp 124 shown in FIG. 2. When the cylindrical motor housing portion 130 is securely clamped using the clamp 124, the axis 122 defined by the cylindrical motor receiving portion bore 120 (FIG. 2) is aligned with an axis 142 (see FIG. 3) defined by the output shaft 138.

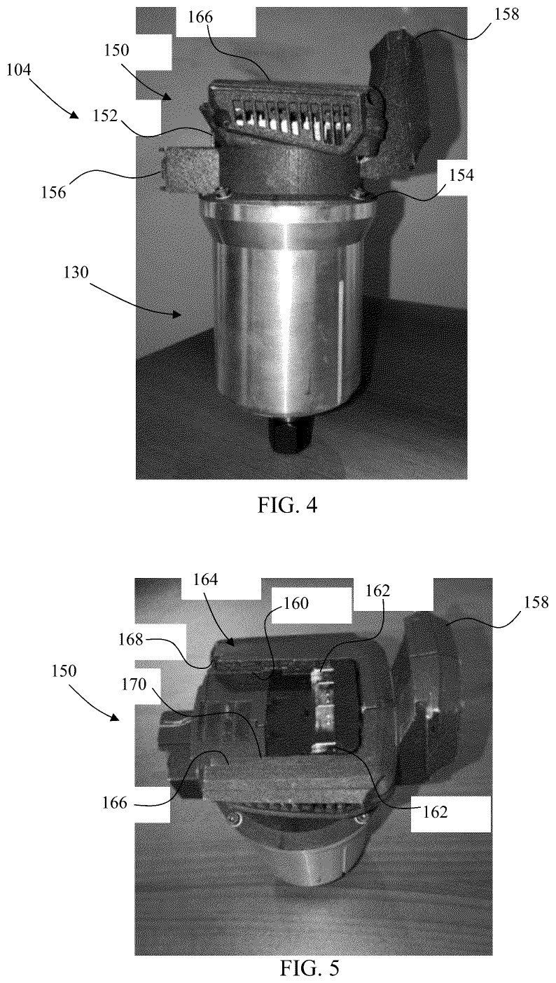

The power portion 104 further includes a battery receptacle portion 150 which is further depicted in FIG. 4. The battery receptacle portion 150 includes a housing 152. A coupling portion 154 of the housing 152 is provided to fixedly couple the battery receptacle portion 150 with the cylindrical motor housing portion 130 using the coupling portion 136. A power switch 156 which controls supply of energy to the motor is provide on one side of the battery receptacle portion 150 while a display housing 158, which in some embodiments is integrally formed with the battery receptacle portion 150, is provided on the opposite side (as shown in FIG. 4) of the battery receptacle portion 150.

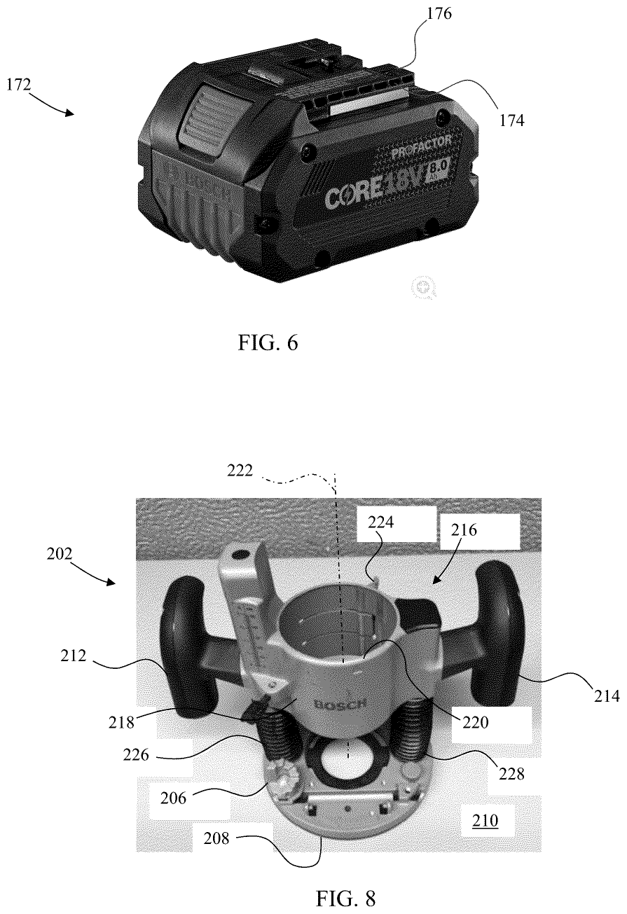

With reference first to FIG. 5, at an upper side of the battery receptacle portion 150 a battery receiving cavity 160 is provided. Within the battery receiving cavity 160 a number of electrical contacts 162 are provided. A mouth 164 of the battery receiving cavity 160 is defined in part by an upper planar surface 166 and a side surface 168 and provides access to mechanical coupling structures 170 of the battery receiving cavity 160. The battery receiving cavity 160 is configured to removably receive at least a portion of a battery 172 therein (see FIG. 1). The battery 172, shown in FIG. 6, includes mechanical coupling structures 174 and electrical contact receiving structures 176. When the battery 172 is coupled with the battery receptacle portion 150, the electrical contacts 162 are placed in electrical contact with electrical contact receiving structures 176 when the mechanical coupling structures 176 of the battery 172 couple with the mechanical coupling structures 170 of the battery receiving cavity 160.

The display housing 158 extends to a location above the upper planar surface 166 as shown in FIG. 4. This configuration allows for the inclusion of a large display 180 which is shown in FIG. 1. The large display 180 provides space for an increased number of data icons 182 to be presented to a user. In some embodiments, the display 180 provides for the display of text in place of or in addition to icons. Accordingly, a significant increase in the amount of data regarding the router assembly 100 can be presented to a user without the need of external devices such as a smartphone.

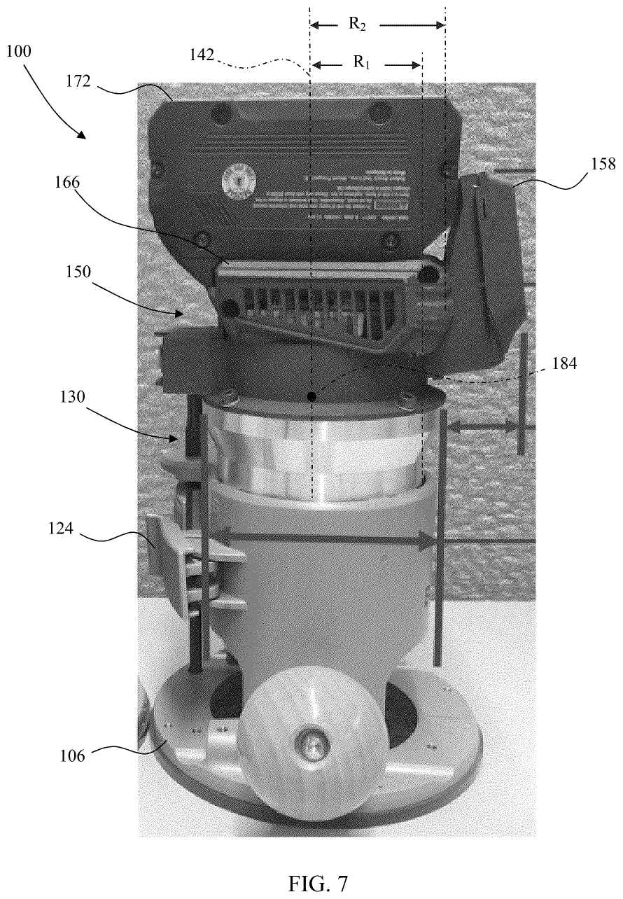

The configuration of the display housing 158 and display 180 provides for enhanced data dissemination while providing for optimal location of the center of gravity of the router assembly 100 while further not interfering with operation of the router assembly 100. In particular, FIG. 7 shows the radius R₁ of the cylindrical motor receiving portion bore 120 and the innermost radius R₂ of the display housing 158 with respect to the axis 142 defined by the output shaft 138, with R₂>R₁. Because the display housing 158 is thus positioned outwardly of R₁, the battery 172 can be positioned so as to be substantially centered over the cylindrical motor receiving portion bore 120 (within R₁) on the axis 142. Consequently, the center of gravity 184 of the assembled router assembly 100 is located in some embodiments on the axis 142 defined by the output shaft 138. In other embodiments, the center of gravity 184 of the assembled router assembly 100 is located substantially on the axis 142. This provides for increased control of the router assembly 100 by a user.

Moreover, because the location of the display housing 158 is offset from the axis 142 by the radius R₂, the battery 172 can be located closer to the foot portion 106, thereby lowering the location of the center of gravity which provides for a more stable platform. As shown in FIG. 7, even when the battery 172 is configured with a portion of the battery extending beyond the radius R₂ the display housing 158 can be made to accommodate the excursion with only a slight modification in the shape of the display housing 158. In particular, the inner portion of the display housing 158 is angled to accommodate the battery 172. Thereby allowing for an even lower placement of the battery 172.

The display housing 158 was described with respect to a mouth which provided for horizontal mounting of the battery 172 from the rear of the device. Because the display housing is offset from the axis defined by the shaft, however, the mouth of the cavity in other embodiments is configured to provide horizontal mounting of the battery 172 from the rear of the device or vertical mounting of the battery.

While the disclosure has focused on an embodiment which includes a fixed base portion 102, the disclosed power portion 104 can likewise be incorporated into a plunge type base portion. For example, FIG. 8 shows a base portion 202 which can be used with the power portion 104. The base portion 202 includes a foot portion 206 with a workpiece contact surface 208 which is configured to be positioned on the surface of a workpiece 210. The workpiece contact surface 208 is provided as a planar component to allow for movement along the workpiece 210. Two handles 212/214 are coupled to the foot portion 206 to allow a user to easily move the router assembly along the plane defined by the planar contact surface 208.

Located above the foot portion 206 is a cylindrical motor receiving portion 216. The cylindrical motor receiving portion 216 includes a wall portion 218 which defines a cylindrical motor receiving portion bore 220. The cylindrical motor receiving portion bore 220 defines a central axis 222 which is perpendicular to the plane defined by the workpiece contact surface 208. Also shown in FIG. 8 is a clamp 224.

The base portion 202 is thus functionally similar to the base portion 102. The main difference with the base portion 202 is that the foot portion 206 is connected to the cylindrical motor receiving portion 216 by the provision of two plunge posts 226 and 228. The plunge posts 226/228 allow the cylindrical motor receiving portion 216 to be moved toward the foot portion 206 to provide plunge capability.

The disclosure thus provides a configuration in which, when the battery is coupled with the battery receptacle, the center of gravity of the assembled router assembly is substantially aligned with the center of gravity of the output shaft of the router assembly. The configuration further allows a battery to be mounted relatively low on a base with high walls while still providing for a large display to be incorporated into the assembly.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A router assembly comprising:
a base portion including
a foot portion with a workpiece contact surface, the workpiece contact surface configured to be positioned on the surface of a workpiece, and
a cylindrical motor receiving bore above the foot portion;
a cylindrical motor housing portion configured to be clamped within the cylindrical motor receiving bore;
a battery receptacle portion fixedly positioned with respect to the cylindrical motor housing portion and configured to couple with a battery, the battery receptacle portion including a cavity with a mouth providing access to coupling structures in the cavity, an uppermost part of the mouth defined at least in part by a horizontally extending planar surface portion; and
a display supported by the cylindrical motor housing portion such that when the battery is coupled with the battery receptacle portion, with at least a portion of the battery within the cavity, at least a portion of the display is positioned higher than the uppermost planar surface portion.

2. The router assembly of claim 1, wherein:
the battery receptacle portion includes a battery receptacle housing coupled to the motor housing;
the display is mounted in a display housing portion; and
at least a portion of the display housing portion is integrally formed with at least a portion of the battery receptacle housing.

3. The router assembly of claim 2, wherein:
the workpiece contact surface defines a first plane;
the cylindrical motor receiving bore defines a first axis perpendicular to the first plane;
the cylindrical motor receiving bore defines a first radius from the first axis;
a radially innermost portion of the display housing defines a second radius from the first axis; and
the second radius is larger than the first radius.

4. The router assembly of claim 3, wherein the router assembly is configured such that when the battery is coupled with the battery receptacle, a center of gravity of the assembled router assembly is substantially aligned with a second axis defined by an output shaft of the router assembly.

5. The router assembly of claim 4, wherein the base portion is a fixed base portion.

6. The router assembly of claim 5, further comprising:
the battery, wherein the battery includes
mechanical coupling structures configured to couple with the battery receptacle portion coupling structures, and
electrical contact structures spaced apart from the mechanical coupling structures and configured to provide electrical connectivity with the battery receptacle portion.

7. The router assembly of claim 4, wherein the base portion is a plunge base portion.

8. The router assembly of claim 7, further comprising:
the battery, wherein the battery includes
mechanical coupling structures configured to couple with the battery receptacle portion coupling structures, and
electrical contact structures spaced apart from the mechanical coupling structures and configured to provide electrical connectivity with the battery receptacle portion.

9. A power portion for a router assembly, comprising:
a cylindrical motor housing portion configured to be clamped within a cylindrical motor receiving bore of a base portion of the router assembly;
a battery receptacle portion fixedly positioned above the cylindrical motor housing portion and configured to couple with a battery, the battery receptacle portion including a cavity with a mouth providing access to coupling structures in the cavity, an uppermost part of the mouth defined at least in part by a horizontally extending planar surface portion; and
a display supported by the cylindrical motor housing portion with at least a portion of the display positioned higher than the horizontally extending planar surface portion, wherein the cavity is configured to receive at least a portion of the battery when the battery is coupled to the battery receptacle portion using the coupling structures.

10. The power portion of claim 9, wherein:
the battery receptacle portion includes a battery receptacle housing coupled to the motor housing;
the display is mounted in a display housing portion; and
at least a portion of the display housing portion is integrally formed with at least a portion of the battery receptacle housing.

11. The power portion of claim 10, wherein:
the cylindrical motor receiving bore defines an axis;
the cylindrical motor receiving bore defines a first radius from the axis;
a radially innermost portion of the display housing defines a second radius from the axis; and
the second radius is larger than the first radius.
